(19) United States
(12) Patent Application Publication
(10) Pub. No.: US 2015/0254426 A1
(43) Pub. Date: Sep. 10, 2015

(54) Method and Apparatus for Preparing Medications for Administration to Subjects

(71) Applicant: Yariv Glazer, Be'er Tuvia (IL)

(72) Inventor: Yariv Glazer, Be'er Tuvia (IL)

(21) Appl. No.: 14/203,432

(22) Filed: Mar. 10, 2014

(51) Int. Cl. G06F 19/00

(52) U.S. Cl. CPC G06F 19/3456

(57) ABSTRACT

A method and apparatus for preparing a plurality of medications for administration to a subject during one session, which medications include active ingredients each of a specified concentration for the respective medication, by: preparing a supply of each of the active ingredients; separating from each supply a quantity of the respective active ingredient corresponding to the specified concentration for the respective medication; mixing the separated quantities of active ingredients with at least one additive to produce a formulation mixture; and forming the resulting formulation mixture into a batch of personalized single units for administration to, and personalized for, the subject during the one session.

### RELATED APPLICATION

This application is a continuation application of U.S. Provisional Application No. 61/778,420, filed Mar. 13, 2013, and incorporates by reference the disclosure therein.

### FIELD AND BACKGROUND OF THE INVENTION

The present invention relates to methods and apparatus for preparing medications for administration to subjects, and particularly to such methods and apparatus for preparing a plurality of medications for administration to subjects in each of a plurality of sessions during the course of a day.

Persons taking medications usually take several in each of a plurality of sessions during the course of a day, for example in the morning, mid-day, and evening. Many patients, especially those with chronic conditions like diabetes and heart disease, do not adhere to medication regimens. Studies show only 25%-30% of medications are taken properly, and only 15%-20% are refilled as prescribed.

Various devices have been developed to assure that the proper medications are taken at the proper times. Medication holders have been developed which define a plurality of compartments and sub-compartments for holding the appropriate medications for the respective session. For example, where various medications are to be taken in three different sessions during each day, such holders are divided into separate compartments, one for each day of the week, with each compartment sub-divided into three separate sub-compartments, each intended to hold the medications for the respective session of the respective day.

Such existing systems have a number of drawbacks. For example, they are prone to errors or forgetfulness in adding, or failing to add, to the respective sub-compartment a medication required for the respective session. In addition, the cost of such medications is very high and can be substantially lowered since the cost of preparing a medication having the active ingredient in high concentration is only slightly higher than a medication having the active ingredient in low concentration; in fact, patients are frequently advised to purchase double-strength forms of medications and to cut such medication in half, to thereby reduce the overall cost of the medications to the patient. Further, swallowing a plurality of separate pills, tablets or capsules, in one session may be inconvenient, or even very difficult, with some patients.

### OBJECTS AND BRIEF SUMMARY OF THE PRESENT INVENTION

An object of the present invention is to provide a method and apparatus for preparing medications for administration to subjects having advantages in one or more of the above respects.

According to one aspect of the present invention, there is provided a method of preparing a plurality of medications for administration to a subject during one session, said medications including active ingredients each of a specified concentration for the respective medication, said method comprising the following operations: preparing a supply of each of said active ingredients; separating from each supply a quantity of the respective active ingredient corresponding to the specified concentration for the respective medication; mixing the separated quantities of active ingredients with at least one additive to produce a formulation mixture; and forming said formulation mixture into a batch of personalized single units for administration to, and personalized for, the subject during said one session.

The term “medications”, as used herein, refers to any substance which is to be administered to a subject for the purpose of therapy, health or diagnosis, and includes prescription drugs, non-prescription substances, vitamins, food supplements, binders, carriers, taste enhancers, etc. The term “administration” or “administers”, as used herein, refers to the process by which the medication is received by the subject, e.g., by mouth, by injection or by inhalation. The “subject” may be a person or an animal.

Several preferred embodiments are described, for purposes of example, including one wherein the mixing operation includes adding at least one marker capable of indicating whether a personalized single unit produced during the forming operation was actually swallowed by the subject.

Preferably, but not necessarily, the preparing operation includes preparing each supply with the respective active ingredient in powder form, and the separating operation includes separating, by weighing, a quantity of the respective active ingredient corresponding to the specified concentration for the respective medication. The active ingredient may be directly prepared in powder form, or may be prepared first in solid form, and then rendered into powdered form by crushing, etc.

According to another aspect of the present invention, there is provided apparatus for preparing a plurality of medications according to the above described method.

### BRIEF DESCRIPTION OF THE DRAWINGS

The invention is herein described, by way of example only, with reference to the accompanying drawings, wherein:

FIG. 1 is a block diagram illustrating the basic operations in the overall method of the present invention;

FIG. 2 is a block diagram illustrating one form of apparatus for performing the method of FIG. 1; and

FIG. 3 schematically illustrates one form of mixing controller according to the present invention.

### DESCRIPTION OF PREFERRED EMBODIMENTS

### The Overall Method and Apparatus

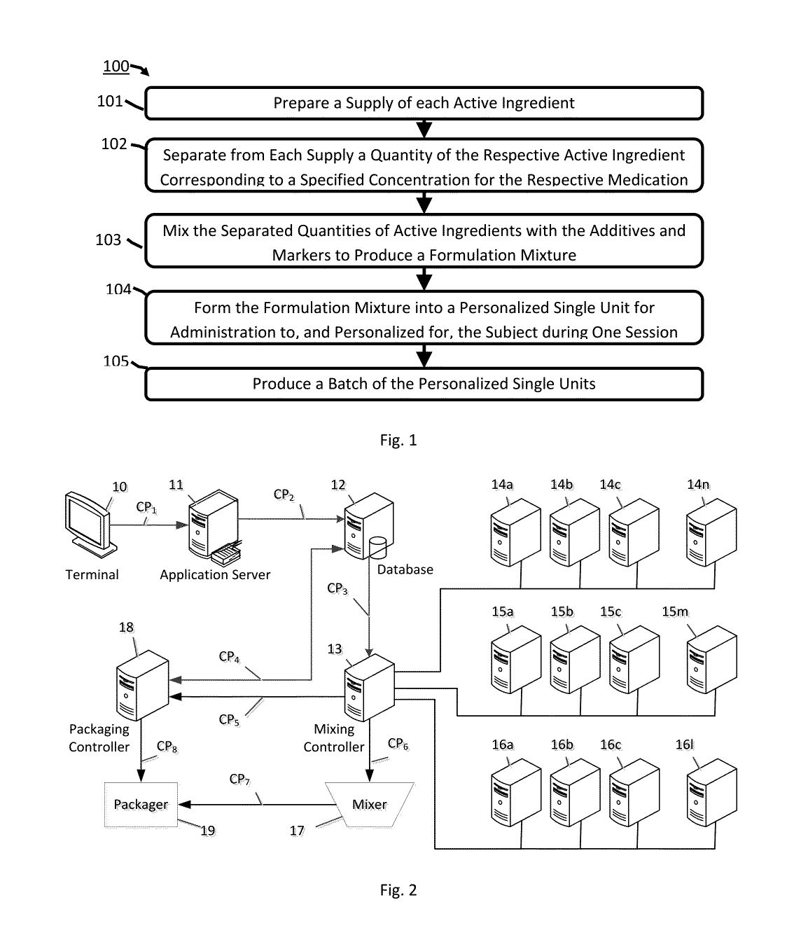

FIG. 1 is a block diagram illustrating the basic operations in the overall method of the present invention, as follows: preparing a supply of each active ingredient, as indicated by block 2; separating from each supply a quantity of the respective active ingredient corresponding to the specific concentration for the respective medication, as indicated by block 3; mixing the separated quantities of active ingredients with one or more additives and markers to produce a formulation mixture, as indicated by block 4; forming the formulation mixture into a personalized single unit for administration to, and personalized for, the subject during one session, as indicated by block 5; and outputting a batch of the personalized single units to the user, as indicated by block 6.

It will be appreciated that all the operations shown in FIG. 1 can be used to produce a batch of personalized single units each of which is to be taken alone during the respective one session, or to be taken with other medications if the so-produce personalized unit does not include all the required medications. That is, the method and apparatus can produce all the medications to be taken in one session in the form of one single unit, or in the form of a plurality of single units, as personalized for a respective subject.

### The Embodiment of FIG. 2

With respect to the apparatus illustrated in FIG. 2, it will be seen that it includes a terminal 10 serving as a user interface for inputting and outputting data; an application server 11 serving to interface the terminal 10 with the database 12, which is normally in the form of a lookup table storing the data to be used; a mixing controller 13 for controlling the mixing of the various ingredients, namely the active ingredients in holders 14a-14n, the additive ingredients in holders 15a-15m, and the marker ingredients in holders 16a-16l; a mixer 17 controlled by the mixing controller 13; and a packager 19 controlled by packaging controller 18 packaging the produced, personalized one-unit medications.

Also shown in FIG. 2 are the communication paths between the various components described above, namely path CP1 providing communication between the terminal 10 and the application server 11, communication path CP2 providing communication between the application server 11 and the database 12; communication path CP3 providing communication between the database 12 and the mixing controller 13; communication path CP4 providing communication between the database 12 and the packaging controller 18; communication path CP5 providing communication between mixing controller 13 and the packaging controller 18; and communication path CP6 providing communication between the mixing controller and the mixer 17. Separate communication paths CP7, CP8 provide communication between the mixer 17 and the packager 19, and between the packaging controllers 18 and the packager 19, respectively. These communication paths may be wired, wireless, or a combination of both types of paths.

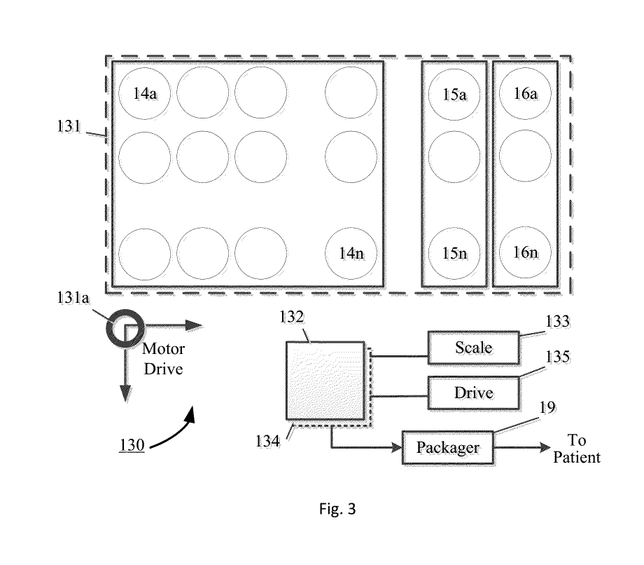

### The Embodiment of FIG. 3

FIG. 3 illustrates an embodiment of the invention wherein the apparatus receives the active ingredients, as well as other ingredients, in powder form and uses a scale for determining, by weighing, the quantity of each to be separated in order to produce the specified concentration in the personalized single unit for the respective session.

Thus, as shown in FIG. 3, the mixing controller, therein generally designated 130, controls the mixer 17 (FIG. 2) which receives the respective ingredients in powder form. The ingredient holders, as schematically shown in FIG. 3, include a plurality (generally a large number e.g., over 20) of active ingredient holders 14a-14n, a plurality (generally a smaller number, e.g., less than 20) of additive ingredient holders 15a-15n, and one or more (e.g., less than 10) marker ingredient holders 16a-16n. All the holders are mounted on a common movable platform or carriage 131, driven along two axes by a motor 131a, for selectively locating each of the holders with respect to the mixer 17 controlled by the mixing controller 130.

The mixing controller 130 is schematically indicated in FIG. 3 as also including an upper receiving plate 132 controlled by a scale 133 so as to be driven either to the normal horizontal position shown in FIG. 3, or to a vertical position for depositing, on a bottom plate 134, the quantity of powder ingredient corresponding to the selected specified concentration. FIG. 3 also schematically shows that the bottom plate 134 is movable, under the control of a drive 135, either to the normal horizontal position for receiving the quantity of powder thereon, or to a vertical position for discharging the specified quantity into the mixer 17 to be used in forming the personalized single units.

### EXAMPLES

### Example 1

A patient needs to take 20 different medications in 5 distinct sessions during the day. The combination and the number of pills are usually different in each session. The physician of the patient specifies all the prescriptions with the appropriate doses for each session for the respective patient. The pharmacy enters the new order into the database 12, via terminal 10 and application server 11. Mixing controller 13 controls the ingredients added to the mixer 17 to create a batch of personalized, single, clearly marked pills each containing all the active ingredients prescribed for the respective session of the day, and for the number of days of the prescription. The mixer 17 directs the pills to the packager 19, which prepares the order to be shipped to the patient under the control of the packaging controller 18.

### Example 2

Many women take birth control pills every day in addition to other medicines for thyroid and other hormonal imbalances. Many also take vitamins or other supplements to achieve a better nutritional diet. Producing single personalized pills, each containing all the active ingredients required for the respective session, better assures that all the required medications will indeed be taken and none will be omitted. Moreover, it enables all medications to be taken in a manner that is not only more convenient, but is also substantially less costly, to the user.

### Example 3

Multi-vitamin tablets are becoming popular. These tablets often lack many ingredients needed by a specific user, causing the user to add unnecessary vitamins and other supplements to their daily intake. Creating a personalized multi-vitamin pill using the novel method and apparatus will limit significantly the number of pills taken by a person and will allow the person to take all vitamins in only one or two pill.

### Example 4

Many elderly persons struggle with swallowing large pills. By using the novel method and apparatus, the pharmacy will be able to create a personalized pill containing many or all the session's active ingredients within smaller, personalized, easy to swallow pills.

### Example 5

Some patients require complicated regimens of many medications to be taken in a plurality of daily sessions. Following is an example for one session including 8 specific active ingredients, 4 specific additives, and a specific marker for the specified active ingredients. The active ingredients include: (1) Lopressor and (2) Prinivil, for high blood pressure; (3) Citalopram, for depression; (4) Sotalol, for antiarrhythmic problems; (5) Coumadin, for preventing blood clots; (6) Ecotrin, for rheumatoid arthritis; (7) Lasix, for reducing swelling and fluid retention; and (8) Avodart, for benign prostatic hyperplasia. In this example the additives include: (1) Ocuvite, vitamins for the eyes; (2) Omega-3; (3) Potassium Chloride; and (4) Vitamin C. A unique marker, such as a nano-RFID, is added to the personalized capsule to indicate (in case of emergency) to the medical personnel that the list above has been consumed by the person in the respective session.

While the invention is herein described with respect to several preferred embodiments, it will be appreciated that these are set forth merely for purposes of example, and many other variations, modifications and applications of the present invention may be made.

What claimed is:

1. A method of preparing a plurality of medications for administration to a subject during one session, said medications including active ingredients each of a specified concentration for the respective medication, said method comprising the following operations:
preparing a supply of each of said active ingredients;
separating from each supply a quantity of the respective active ingredient corresponding to the specified concentration for the respective medication;
mixing the separated quantities of active ingredients with at least one additive to produce a formulation mixture;
and forming said formulation mixture into a batch of personalized single units for administration to, and personalized for, the subject during said one session.

2. The method according to claim 1, wherein, in said mixing operation, a quantity of said at least one additive ingredient is mixed with said separated quantities of active ingredients such that each single unit formed in said forming operation is also personalized as to size.

3. The method according to claim 1, wherein the plurality of medications are to be administered to the subject by swallowing.

4. The method according to claim 3, wherein said mixing operation includes adding at least one marker capable of indicating whether the personalized single unit produced during the forming operation was actually swallowed by the subject.

5. The method according to claim 1, wherein said preparing operation includes preparing each supply with the respective active ingredient in powder form; and said separating operation includes separating, by weighing, a quantity of the respective active ingredient corresponding to the specified concentration for the respective medication.

6. The method according to claim 1, wherein the personalized single unit is formed into a pill or tablet for swallowing by the subject.

7. The method according to claim 1, wherein the personalized single unit is formed into a capsule for swallowing by the subject.

8. The method according to claim 1, wherein the personalized single unit is formed into a liquid for injection into the subject.

9. Apparatus for preparing a plurality of medications for administration to a subject during one session, said medications including active ingredients each of a specified concentration for the respective medication, said apparatus comprising:
a plurality of active ingredient holders for holding a supply of each of said active ingredients;
at least one additive ingredient holder for holding a supply of at least one additive ingredient;
an input terminal for inputting data;
a database for storing inputted data;
a mixer and mixing controller for controlling the preparation of the medications to be administered in said one session;
and a packager and packaging controller for controlling the packaging of the medications prepared by said apparatus;
characterized in that said mixing controller is designed:
to separate from each supply a quantity of the respective active ingredient corresponding to the specified concentration for the respective medication;
to mix in said mixer the separated quantities of active ingredients with at least one additive to produce a formulation mixture;
and to form said formulation mixture into a batch of personalized single units each for administration to, and personalized for, the subject during said one session.

10. The apparatus according to claim 9, wherein said mixing controller is designed such that, in said mixing operation, a quantity of said at least one additive is mixed with said separated quantities of active ingredients such that each produced single unit is also personalized as to size in said forming operation.

11. The apparatus according to claim 9, wherein said mixing operation includes adding at least one marker capable of indicating whether the personalized single unit produced during the forming operation was actually swallowed by the subject.

12. The apparatus according to claim 9, wherein said preparing operation includes preparing each supply with the respective active ingredient in powder form; and said separating operation includes separating, by weighing, a quantity of the respective active ingredient corresponding to the specified concentration for the respective medication.

13. The apparatus according to claim 9, wherein said mixing controller is designed such that the personalized single unit is formed into a pill or tablet for swallowing by the subject.

14. The apparatus according to claim 9, wherein said mixing controller is designed such that the personalized single unit is formed into a capsule for swallowing by the subject.

15. The apparatus according to claim 9, wherein said mixing controller is designed such that the personalized single unit is formed into a liquid for injection into the subject.
